(19) United States
(12) Patent Application Publication
(10) Pub. No.: US 2023/0169352 A1
(43) Pub. Date: Jun. 1, 2023

(54) GENERATE SOURCE CODE TO BUILD SECURE MACHINE LEARNING ENGINE FOR EDGE DEVICES AND EXISTING TOOLCHAINS

(71) Applicants: Haijun ZHAO, San Diego, CA (US); QUALCOMM Incorporated, San Diego, CA (US)

(72) Inventor: Haijun ZHAO, Beijing (CN)

(21) Appl. No.: 17/997,307

(22) PCT Filed: Jun. 12, 2020
(86) PCT No.: PCT/CN2020/095790

§ 371 Date: Oct. 27, 2022

(51) Int. Cl. G06N 3/10

(52) U.S. Cl. CPC G06N 3/10

(57) ABSTRACT

Various embodiments include methods and devices for generating source code of one or more trained machine learning models for use with an existing toolchain of an edge processing device. Embodiments may include parsing a trained machine learning model, generating weight data from the parsed trained machine learning model, generating layer code from the parsed trained machine learning model, and generating a network construct source code of the trained machine learning model from the weight data and the layer code in which the network construct source code is compileable for and executable by the edge processing device.

### BACKGROUND

Various types of computing hardware, such ultra-low power processors, like a sensor digital signal processor (DSP), a modem DSP, a memory control unit (MCU), etc., use dedicated firmware toolchains, which are difficult to adapt dynamically for an end-to-end machine learning ecosystem. Some of the machine learning packages are not open source or currently available for use with a computing hardware's existing, specific firmware toolchain, and use executable files that do not allow for full integration with existing code for use with the computing hardware. Some of the machine learning packages require a new, dedicated toolchain/integrated development environment (IDE) rather than repurposing existing microcontrollers. Existing vendor dedicated machine learning software development kits (SDK) libraries consume too many resources to be ported to computing hardware, like embedded processors, and the time to market for SDKs for specific computing hardware is slow.

### SUMMARY

Various disclosed aspects may include methods and apparatuses for implementing methods for generating source code of one or more trained machine learning models for use with an existing toolchain of an edge processing device. Various aspects may include parsing a trained machine learning model, generating weight data from the parsed trained machine learning model, generating layer code from the parsed trained machine learning model, and generating a network construct source code of the trained machine learning model from the weight data and the layer code, in which the network construct source code is compileable for and executable by an the edge processing device.

In some aspects, generating weight data from the parsed trained machine learning model may include identifying weights in the trained machine learning model, extracting the weights of the trained machine learning model, and storing the extracted weights as the weight data.

In some aspects, generating layer code from the parsed trained machine learning model may include identifying network layers in the trained machine learning model, selecting layer templates corresponding to the identified network layers, and storing contents of the layer templates as the layer code.

In some aspects, generating a network construct source code may include generating source code initializing weights using the weight data, generating source code initializing network layer objects using the layer code, and generating source code for network layer execution using the layer code.

In some aspects, generating weight data from the parsed trained machine learning model may include generating a header file having weights of the trained machine learning model.

In some aspects, generating layer code from the parsed trained machine learning model may include generating a source code file having network layer objects and network layer execution code for network layers of the trained machine learning model.

In some aspects, generating a network construct source code of the trained machine learning model may include generating a C programming language source code file having source code initializing weights of the trained machine learning model, source code initializing network layer objects for network layers of the trained machine learning model, and source code for network layer execution for the network layers of the trained machine learning model.

Further aspects include a computing device having a processor configured to perform operations of any of the methods summarized above. Further aspects include a computing device having means for performing functions of any of the methods summarized above. Further aspects include a non-transitory processor-readable medium having stored thereon processor-executable instructions configured to cause a processor and other components of a computing device to perform operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a component block diagram illustrating an example system on chip (SoC) suitable for implementing various embodiments.

FIG. 3 is a component block and flow diagram illustrating an example system for generating source code of trained machine learning models suitable for implementing various embodiments.

FIG. 4 is a computer code block diagram illustrating an example of computer code for generating source code of trained machine learning models suitable for implementing various embodiments.

FIG. 5 is a component block and flow diagram illustrating an example system for generating source code of trained machine learning models and implementing hardware specific software using the generated source code suitable for implementing various embodiments.

FIG. 6 is a process flow diagram illustrating a method for generating source code of trained machine learning models according to some embodiments.

FIG. 7 is a process flow diagram illustrating a method for parsing weights of trained machine learning models according to some embodiments.

FIG. 8 is a process flow diagram illustrating a method for parsing network layers of trained machine learning models according to some embodiments.

FIG. 9 is a process flow diagram illustrating a method for generating source code of trained machine learning models according to some embodiments.

FIG. 10 is a component block diagram illustrating an example mobile computing device suitable for implementing various embodiments.

FIG. 11 is a component block diagram illustrating an example mobile computing device suitable for implementing various embodiments.

FIG. 12 is a component block diagram illustrating an example server suitable for implementing various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments may include methods, and computing devices implementing such methods for generating source code of trained machine learning models. Some embodiments may include generating a source code for a trained machine learning model so that the trained machine learning model may be implemented in software using existing firmware toolchains of hardware devices for which the machine learning model may not be adapted. In some embodiments, generating the source code for the trained machine learning model may include parsing the machine learning model, and extracting weights and identifying network layers of the machine learning model. In some embodiments, the weights may be used to generate weight data for a network construct source code. In some embodiments, the identified network layers may be used to select a layer template and to generate a layer code for the network construct source code using the layer template. In some embodiments, the network construct source code may be generated using the weight data and the layer code. In some embodiments, the network construct source code may be the source code of the trained machine learning model, and the network construct source code may be in a programming language compatible for use by a hardware device, such as a low power hardware device.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers (such as in vehicles and other larger systems), servers, multimedia computers, and game consoles.

The terms “edge processing device” and “edge processor” are used interchangeably herein to refer to processing devices that may use existing, dedicated firmware toolchains for which machine learning models need to be adapted for use with the existing, dedicated firmware toolchains to be implemented by the processing device, and that implement machine learning model processing locally on a computing device. Edge processing devices may have limited compiler capabilities, memory, and/or processing power. Edge processing devices may refer to any or all of low power processors, sensor digital signal processors, modem digital signal processors, memory control units, embedded processors, controllers, microcontrollers, etc.

Various software vendors have developed and trained machine learning models that can be implemented on computing devices developed by computing device developers. For example, trained machine learning models may include Keras, TensorFlow, TensorFlow Lite, PyTorch, Caffe, Caffe 2, MXNet, Android Neural Networks API, Snapdragon Neural Processing Engine (SNPE), etc. Such machine learning models are commonly distributed with software development kit (SDK) libraries for implementation on a computing device. General purpose processors, such as a central processing unit, may use various compilers configured to compile software developed using the machine learning model SDK libraries and execute the compiled software.

However, many edge processing devices may have limited capability to use machine learning model SDKs. These edge processing devices may be unable to compile and execute software developed using the machine learning model SDK libraries. In order for these edge processing devices to make use of the machine learning models, the machine learning model SDKs may have to be adapted to be compatible with existing, dedicated firmware toolchains of the edge processing devices to develop compileable and executable software. For example, a new compiler may need to be developed for edge processing devices for the machine learning model SDKs to be compileable and executable on the edge processing devices.

The landscape of machine learning models and edge processing devices is vast and fragmented. Therefore, adapting the machine learning model SDKs to be compatible with existing, dedicated firmware toolchains of the edge processing devices can incur large resource costs and time to develop for different machine learning model operators, network layers, and/or format conversions. For example, new compilers may need to be developed for multiple edge processing devices that implement different technologies. The process may also introduce inaccuracies to the machine learning models implemented by the edge processing devices. The time to market for adapting machine learning model SDKs for the edge processing devices is slow due to various factors, including openness or availability of the existing firmware toolchains and/or cooperation by hardware developers to adapt the edge processing device hardware. For example, non-opensource or unavailable, existing firmware toolchains may prevent software vendors from knowing how to adapt their machine learning models to the firmware environments of the edge processing devices. As another example, hardware developers may need to be adapted to memory management for the edge processing devices to implement the machine learning models.

Various embodiments described herein solve the forgoing problems by converting trained machine learning models to source code that may be compiled and implemented by edge processing devices. The trained machine learning models source code (referred to herein as network construct source code) may be generated such that a trained machine learning model may be implemented in software created using the existing, dedicated firmware toolchain of an edge processing device without needing to adapt the machine learning model SDK and the processing edge processing device hardware. The network construct source code may be used in the software created using the existing, dedicated firmware toolchain of the edge processing device without using the machine learning model SDK libraries. Using the disclosed embodiments may reduce the time to market for an edge processing device able to implement a trained machine learning model. Various embodiments further allow for greater security for intellectual property and user data protection by not requiring the hardware developers to expose the existing firmware toolchains of the edge processing devices to other parties.

In some embodiments, the network construct source code may be generated in a high-level programming language, such as C, C++Java, Pascal, COBOL, BASIC, etc., that may enable quicker and easier testing and debugging of the network construct source code and the software implementing the trained machine learning model generated using the network construct source code and the existing, dedicated firmware toolchains of the edge processing devices. Further, the network construct source code is portable for any edge processing device configured to compile and implement the programming language of the network construct source code.

In various embodiments, a machine learning model source code generator may receive a trained machine learning model. The machine learning model source code generator may use a machine learning model parser configured to extract weights of the trained machine learning model source code and generate weight data for generating a network construct source code using the extracted weights. The machine learning model parser may be configured to identify network layers of the trained machine learning model, select layer templates for the identified network layers of the trained machine learning model, and generate layer code of the identified network layers using the layer templates for generating the network construct source code. The machine learning model source code generator may use a network construct source code generator configured to generate the network construct source code using the weight data and the layer code generated by the machine learning model parser. The network construct source code may be source code for executing the trained machine learning model using the weights and the network layer structure and flow of the trained machine learning model. The network construct source code may be in a programming language that is compileable and executable by an edge processing device.

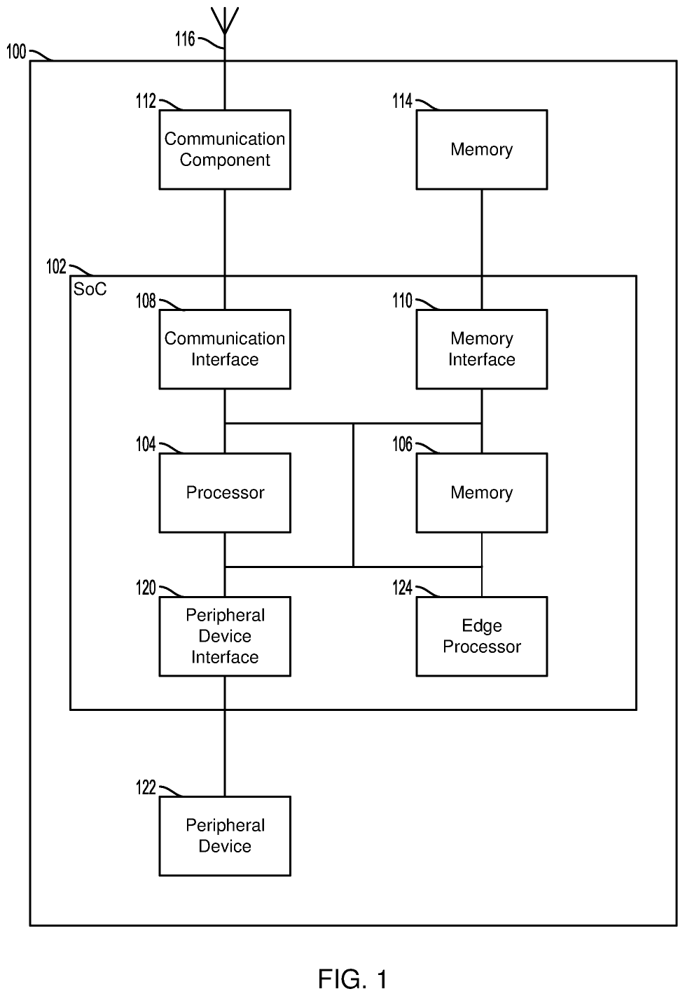

FIG. 1 illustrates a system including a computing device 100 suitable for use with various embodiments. The computing device 100 may include an SoC 102 with a processor 104, a memory 106, a communication interface 108, a memory interface 110, a peripheral device interface 120, and an edge processor 124. The computing device 100 may further include a communication component 112, such as a wired or wireless modem, a memory 114, an antenna 116 for establishing a wireless communication link, and/or a peripheral device 122. The processor 104 may include any of a variety of processing devices, for example a number of processor cores.

The term “system-on-chip” or “SoC” is used herein to refer to a set of interconnected electronic circuits typically, but not exclusively, including a processing device, a memory, and a communication interface. A processing device may include a variety of different types of processors 104 and/or processor cores, such as a general purpose processor, a central processing unit (CPU), a digital signal processor (DSP), a graphics processing unit (GPU), an accelerated processing unit (APU), a secure processing unit (SPU), a subsystem processor of specific components of the computing device, such as an image processor for a camera subsystem or a display processor for a display, an auxiliary processor, a single-core processor, a multicore processor, a controller, and/or a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and/or time references. Integrated circuits may be configured such that the components of the integrated circuit reside on a single piece of semiconductor material, such as silicon.

The SoC 102 may include one or more processors 104. The computing device 100 may include more than one SoC 102, thereby increasing the number of processors 104 and processor cores. The computing device 100 may also include processors 104 that are not associated with an SoC 102. Individual processors 104 may be multicore processors. The processors 104 may each be configured for specific purposes that may be the same as or different from other processors 104 of the computing device 100. One or more of the processors 104 and processor cores of the same or different configurations may be grouped together. A group of processors 104 or processor cores may be referred to as a multi-processor cluster.

The memory 106 of the SoC 102 may be a volatile or non-volatile memory configured for storing data and processor-executable code for access by the processor 104 or by other components of SoC 102, including an edge processor 124. The computing device 100 and/or SoC 102 may include one or more memories 106 configured for various purposes. One or more memories 106 may include volatile memories such as random access memory (RAM) or main memory, or cache memory. These memories 106 may be configured to temporarily hold a limited amount of data received from a data sensor or subsystem, data and/or processor-executable code instructions that are requested from non-volatile memory, loaded to the memories 106 from non-volatile memory in anticipation of future access based on a variety of factors, and/or intermediary processing data and/or processor-executable code instructions produced by the processor 104 and/or edge processor 124 and temporarily stored for future quick access without being stored in non-volatile memory. In some embodiments, any number and combination of memories 106 may include one-time programmable or read-only memory.

The memory 106 may be configured to store data and processor-executable code, at least temporarily, that is loaded to the memory 106 from another memory device, such as another memory 106 or memory 114, for access by one or more of the processors 104 or by other components of SoC 102, including the edge processor 124. The data or processor-executable code loaded to the memory 106 may be loaded in response to execution of a function by the processor 104 or by other components of SoC 102, including the edge processor 124. Loading the data or processor-executable code to the memory 106 in response to execution of a function may result from a memory access request to the memory 106 that is unsuccessful, or a “miss,” because the requested data or processor-executable code is not located in the memory 106. In response to a miss, a memory access request to another memory 106 or memory 114 may be made to load the requested data or processor-executable code from the other memory 106 or memory 114 to the memory 106. Loading the data or processor-executable code to the memory 106 in response to execution of a function may result from a memory access request to another memory 106 or memory 114, and the data or processor-executable code may be loaded to the memory 106 for later access.

The memory interface 110 and the memory 114 may work in unison to allow the computing device 100 to store data and processor-executable code on a volatile and/or non-volatile storage medium, and retrieve data and processor-executable code from the volatile and/or non-volatile storage medium. The memory 114 may be configured much like an embodiment of the memory 106 in which the memory 114 may store the data or processor-executable code for access by one or more of the processors 104 or by other components of SoC 102, including the edge processor 124. in some embodiments, the memory 114, being non-volatile, may retain the information after the power of the computing device 100 has been shut off. When the power is turned back on and the computing device 100 reboots, the information stored on the memory 114 may be available to the computing device 100. In some embodiments, the memory 114, being volatile, may not retain the information after the power of the computing device 100 has been shut off. The memory interface 110 may control access to the memory 114 and allow the processor 104 or other components of the SoC 102, including the edge processor 124, to read data from and write data to the memory 114.

The SoC 102 may also include any number of edge processors 124. An edge processor 124 may be a processing device that may use existing, dedicated firmware toolchains for which machine learning models need to be adapted for use with the existing, dedicated firmware toolchains to be implemented by the edge processor 124. The edge processor may implement machine learning model processing locally on the computing device 100. The edge processor 124 may have limited compiler capabilities, memory, and/or processing power as compared to non-low power processor, such as non-low power CPUs, GPUs, etc.

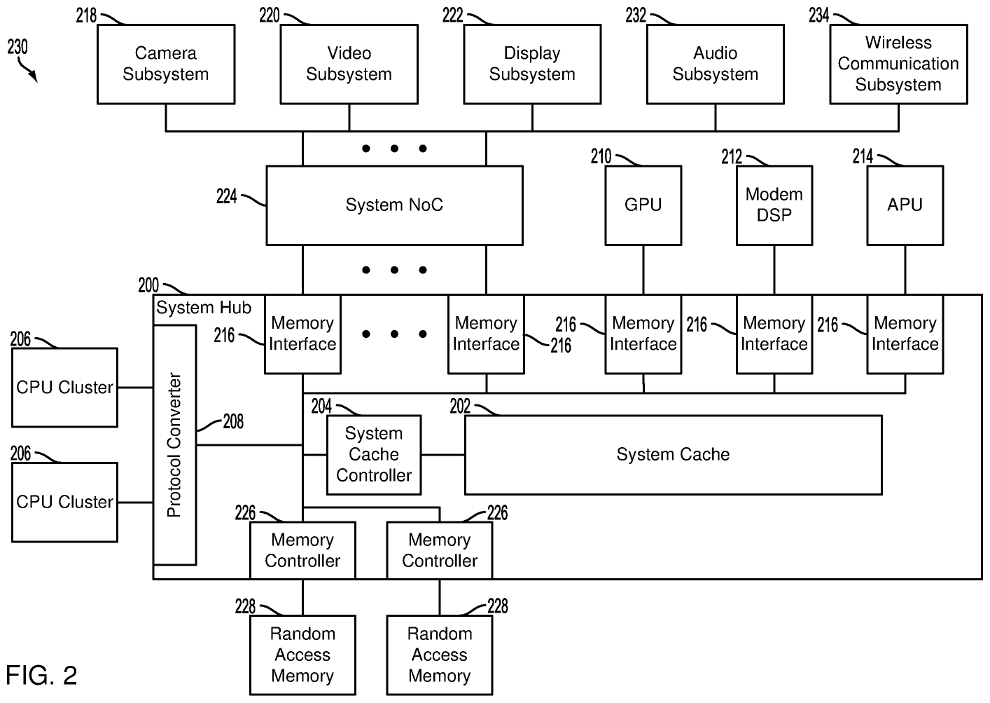

The edge processor 124 may include any of a low power processor, a sensor DSP, a modem DSP, a memory control unit (MCU), an embedded processor, a controller, a microcontroller, etc. The edge processor(s) 124 may be individual components of the SoC 102 and/or integral components of other SoC components, such as the communication interface 108, the memory interface 110, and/or the peripheral device interface 120. The computing device 100 may also include edge processors 124 that are not associated with the SoC 102. Such edge processors 124 may be standalone components of the computing device 100 and/or integrated into other SoCs 1102 and/or other computing device components, such as communication components 102 and peripheral devices 122. Further examples of the edge processor 124 are described with reference to FIG. 2.

Some or all of the components of the computing device 100 and/or the SoC 102 may be arranged differently and/or combined while still serving the functions of the various embodiments. The computing device 100 may not be limited to one of each of the components, and multiple instances of each component may be included in various configurations of the computing device 100.

FIG. 2 illustrates an SoC 230 (e.g., SoC 102 in FIG. 1), which may be a component of a computing device (e.g., computing device 100 in FIG. 1) with multiple peripheral device components suitable for implementing an embodiment. With reference to FIGS. 1 and 2, the SoC 230 may include a variety of components as described above. Some such components and additional components may be subsystems of the computing device 100.

The SoC 230 may include various communication components (e.g., commination interface 108, memory interface 110, peripheral device interface 120 in FIG. 1) configured to communicatively connect the components of the SoC 230 that may transmit, receive, and share data. The communication components may include a system hub 200, a protocol converter 208, and a system network on chip (NoC) 224. The communication components may facilitate communication between subsystem components. Subsystem components may include processors (e.g., processor 104 in FIG. 1) in CPU clusters 206. Subsystem components may also include various peripheral device subsystems (e.g., communication component 112, peripheral device 122 in FIG. 1) having one or more edge processors (e.g., edge processor(s) 124 in FIG. 1), such as camera, video, display, audio, and wireless communication subsystems 218, 220, 222, 232, 234. Subsystem components may further include other specialized processors (e.g., processor 104, edge processor(s) 124 in FIG. 1), such as a graphics processor unit (GPU) 210, a modem digital signal processor (DSP) 212, an application processor unit (APU) 214, and other hardware accelerators. The communication components may facilitate communication between the peripheral device subsystems 218, 220, 222, 232, 234 and the processors 206, 210, 212, 214 with other components such as memory devices (e.g., memory 106, 114 in FIG. 1), including a system cache 202, a random access memory (RAM) 228, and various memories included in the processors 206, 210, 212, 214 and peripheral device subsystems 218, 220, 222, 232, 234, such as cache memories.

Various memory devices (e.g., memory interface 110, edge processor(s) 124 in FIG. 1), such as a system cache controller 204, a memory interface 216, and a memory controller 226, may be configured to control access to the various memories by the peripheral device subsystems 218, 220, 222, 232, 234 and the processors 206, 210, 212, 214 and implement operations for the various memories, which may be requested by the peripheral device subsystems 218, 220, 222, 232, 234 and the processors 206, 210, 212, 214.

The peripheral device subsystems 218, 220, 222, 232, 234 may also include various processors (e.g., edge processor(s) 124 in FIG. 1), controllers (e.g., edge processor(s) 124 in FIG. 1), sensors, receivers, transmitters, and dedicated memories, such as caches and memory registers, configured for controlling and implementing functionalities of the peripheral devices of the subsystems 218, 220, 222, 232, 234.

The descriptions herein of the SoC 230 and its various components illustrated in FIG. 2 are only meant to be examples and in no way limiting. Several of the components of the illustrated example SoC 230 may be variably configured, combined, and separated. Several of the components may be included in greater or fewer numbers and may be located and connected differently within the SoC 230 or separate from the SoC 230. Similarly, numerous other components, such as other memories, processors, peripheral device subsystems, interfaces, and controllers, may be included in the SoC 230.

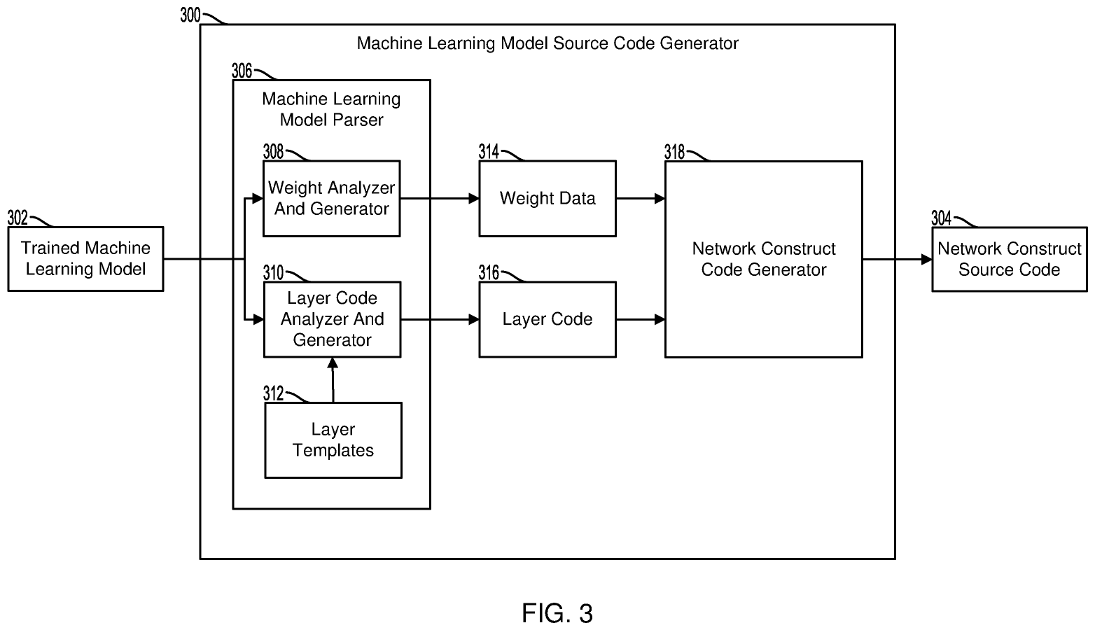

FIG. 3 illustrates an example system for generating source code of trained machine learning models according to various embodiments. With reference to FIGS. 1-3 a machine learning model source code generator 300 may be configured to receive a trained machine learning model 302 and generate a network construct source code 304. The trained machine learning model 302 may include machine learning SDK libraries for the trained machine learning model 302 published and/or distributed by any machine learning software developer. The trained machine learning model 302 may include data and/or code for implementing the trained machine learning model 302, such as weights and network layer type, network layer execution, and/or network layer flow control. The trained machine learning model 302 may include any type of network construct, such as a Bayesian network, a neural network, a decision tree network, etc. The machine learning model source code generator 300 may be configured to generate network construct source code 304 for any number and combination of trained machine learning models 302.

The machine learning model source code generator 300 may include a machine learning model parser 306. The machine learning model parser 306 may be software configured to parse the trained machine learning model 302 for extracting weights from the trained machine learning model 302 for use in generating network construct source code 304. The machine learning model parser 306 may be further configured to parse the trained machine learning model 302 for generating weight data 314 for use in generating network construct source code 304. The machine learning model parser 306 may be software configured to parse the trained machine learning model 302 for identifying network layers of the trained machine learning model 302, select layer templates 312 corresponding to the identifier network layers, and generate layer code 316 for use in generating network construct source code 304. In some embodiments, the machine learning model parser 306 may be a software program having multiple components, such as a weight analyzer and generator 308, a layer code analyzer and generator 310, and/or layer templates 312. In some embodiments, the machine learning model parser 306 may be multiple software programs having various components, such as a first machine learning model parser 306 having the weight analyzer and generator 308 and a second machine learning model parser 306 having the layer code analyzer and generator 310, and/or the layer templates 312.

The weight analyzer and generator 308 may be configured to parse the trained machine learning model 302 to locate and identify eight values of the trained machine learning model 302. The weight analyzer and generator 308 may be configured for any number and combination of trained machine learning models 302. For example, a developer of the weight analyzer and generator 308 may be familiar with the format of the weights in the trained machine learning model libraries and may configure the weight analyzer and generator 308 to locate and identify data that matches criteria for the known format of the weights. For example, the weights may be of a specific data type, stored as a specific data structure, labeled using a specific variable identifier, etc. In some embodiments, different criteria may be used by the weight analyzer and generator 308 to parse the trained machine learning model 302 to locate and identify weight values of different trained machine learning models 302.

The weight analyzer and generator 308 may be configured to extract the weights from the trained machine learning models 302 and generate weight data 314 for use in generating network construct source code 304 from the extracted weights. In some embodiments, to extract the extract the weights from the trained machine learning models 302, the weight analyzer and generator 308 may write out the located and identified weights to a memory (e.g., memory 106, 114 in FIG. 1, system cache 202, RAM 228, and various cache memories described with reference to FIG. 2).

In some embodiments, the weights may be stored as weight data 314 in the memory in a specific format, such as using a specific data type, stored as a specific data structure, labeled using a specific variable identifier, etc. For example, the weight data 314 may be stored in the memory as floating-point values in an array. In some embodiments, the weights may be stored as weight data 314 in the memory in a specific file format. For example, the weight data 314 may be stored in the memory in a header file. In whichever manner the weight data 314 are stored in the memory, the format of the weight data 314 may be a format readable by a network construct source code generator 318, as described further herein.

The layer code analyzer and generator 310 may be configured to parse the trained machine learning model 302 to locate and identify a type of network layer, network layer execution, and/or network layer flow control of the trained machine learning model 302. The layer code analyzer and generator 310 may be configured for any number and combination of trained machine learning models 302. For example, a developer of the layer code analyzer and generator 310 may be familiar with the format of the type of network layer, network layer execution, and/or network layer flow control in the trained machine learning model libraries and may configure the layer code analyzer and generator 310 to locate and identify code that matches criteria for the known format of the type of network layer, network layer execution, and/or network layer flow control. For example, the type of network layer, network layer execution, and/or network layer flow control may use specific function calls, specific code patterns, such as loops, be labeled using specific identifiers, etc. In some embodiments, different criteria may be used by the layer code analyzer and generator 310 to parse the trained machine learning model 302 to locate and identify the type of network layer, network layer execution, and/or network layer flow control of different trained machine learning models 302.

The layer code analyzer and generator 310 may be configured to select a layer template 312 based on the identified type of network layer, network layer execution, and/or network layer flow control. The layer code analyzer and generator 310 may be further configured to generate layer code 316 for use in generating network construct source code 304 from the identified type of network layer, network layer execution, and/or network layer flow control. Each layer template 312 may correspond to a type of layer of a network. Using convolutional neural networks as a non-limiting example, various layer templates 312 may correspond to various convolutional layers, pooling layers, rectified linear unit (ReLU) layers, fully connected layers, etc.

Layer templates 312 may be preconfigured to correspond with any type of network layer. A layer template 312 may be configured to provide source code for execution and flow control of a type of network layer in a programming language that is compileable and executable by an edge processing device (e.g., edge processor(s) 124 and other edge processors described with reference to FIG. 1, modem DSP 212, APU 214, and other edge processors described with reference to FIG. 2). For example, a developer of a layer template 312 may be familiar with the format of the type of network layer, network layer parameters, network layer execution, and/or network layer flow control in the trained machine learning model libraries and may configure the layer template 312 with code for implementing the type of network layer, network layer parameters, network layer execution, and/or network layer flow control in a programming language that is compileable and executable by an edge processing device. For example, the layer template 312 may include specific function calls, specific code patterns, such as loops, specific identifiers, etc. that are configured to implement the type of network layer, network layer parameters, network layer execution, and/or network layer flow control. In some embodiments, different layer templates 312 may include different code for implementing the type of network layer, network layer parameters, network layer execution, and/or network layer flow control for different network layers of different trained machine learning models 302.

The layer code analyzer and generator 310 may be configured to generate layer code 316 using selected layer templates 312. In some embodiments, the layer code analyzer and generator 310 may read the code of the selected layer templates 312 from a memory (e.g., memory 106, 114 in FIG. 1, system cache 202, RAM 228, and various cache memories described with reference to FIG. 2). The layer code analyzer and generator 310 may write out the code of the selected layer templates 312 to the same and/or another memory (e.g., memory 106, 114 in FIG. 1, system cache 202, RAM 228, and various cache memories described with reference to FIG. 2). In some embodiments, the code of the selected layer templates 312 may be stored as layer code 316 in the memory in a specific file format. For example, the layer code 316 may be stored in the memory in a source code file. In whichever manner the layer code 316 are stored in the memory, the format of the layer code 316 may be a format readable by a network construct source code generator 318, as described further herein.

The machine learning model source code generator 300 may include a network construct code generator 318, which may be configured to generate the network construct source code 304. The network construct code generator 318 may be software configured to use the weight data 314 and the layer code 316 to generate source code for the trained machine learning model 302 in a programming language that is compileable and executable by an edge processing device (e.g., edge processor(s) 124 in FIG. 1).

The network construct code generator 318 may read the weight data 314 and generate source code initializing the weight data values in the network construct source code 304. In some embodiments, the network construct code generator 318 may generate source code initializing a data structure having the weight data values. For example, the network construct code generator 318 may initialize an array having the weight data values. The network construct code generator 318 may read the layer code 316 and generate source code for executing the network structure of the network layers of the trained machine learning model 302, including the type of network layer, parameters for the network layer, network layer execution, and/or network layer flow control.

In some embodiments, the construct code generator 318 may generate source code initializing network layer objects and execution and flow control of a network construct of the trained machine learning model 302 using the network layer objects. In some embodiments, the weight data 314 may be used to inform values for parameters of the layer code 316, and the network construct code generator 318 may generate the source code for executing the network structure of the network layers of the trained machine learning model 302 using the parameter values determined from the weight data. For example, the weight data 314 may be used to generate parameters for the sizes, dimensions, and/or number of network layers in the network construct source code 304. The parameters of the layer code 316 may be used as parameters for the initialized network layer objects.

The network construct code generator 318 may write out the network construct source code 304 to a memory (e.g., memory 106, 114 in FIG. 1, system cache 202, RAM 228, and various cache memories described with reference to FIG. 2). In some embodiments, the network construct source code 304 may be stored in the memory in a specific file format. For example, the network construct source code 304 may be stored in the memory in a source code file. In whichever manner the network construct source code 304 are stored in the memory, the format of the network construct source code 304 may be a format compileable and implementable by an edge processing device.

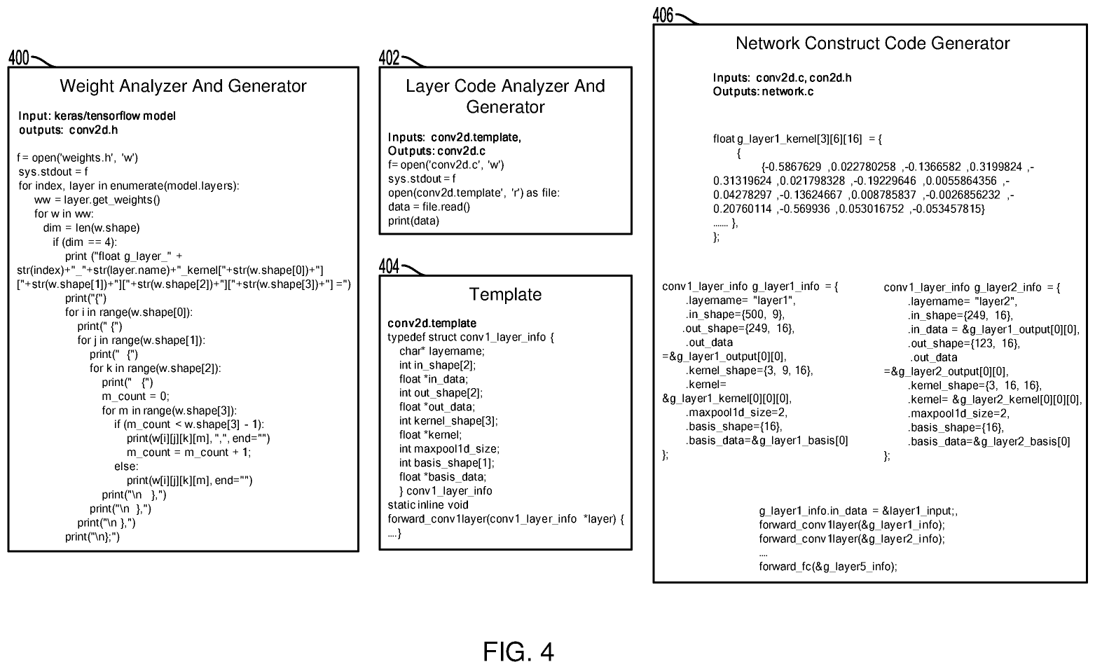

FIG. 4 illustrates example code of the machine learning model source code generator (e.g., machine learning model source code generator 300 in FIG. 3). With reference to FIGS. 1-4, a code block 400 may correspond with the weight analyzer and generator (e.g., weight analyzer and generator 308 in FIG. 3), a code block 402 may correspond with the layer code analyzer and generator (e.g., layer code analyzer and generator 310 in FIG. 3), a code block 404 may correspond with the layer templates (e.g., layer templates 312 in FIG. 3), and a code block 406 may correspond with the network construct code generator (e.g., network construct code generator 318 in FIG. 3). For convenience, the code block 400, the code block 402, the code block 404, and the code block 406 may sometimes be referred to as the first code block 400, the second code block 402, the third code block 404, and the fourth code block 406, respectively.

As shown in the example illustrated in FIG. 4, the code block 400 may use a trained machine learning model (e.g., trained machine learning model 302 in FIG. 3) as an input. In a non-limiting example, the trained machine learning model input to the code block 400 may be Keras and/or TensorFlow. The code block 400 may generate and/or open a weight data file (e.g., weight data 314 in FIG. 3) to which to write the weight data. In a non-limiting example, the weight data file may be a C programing language header file, referred to in FIG. 4 as “weight.h.”

The code block 400 may initialized parameters for generating the weight data. In a non-limiting example, the parameters for generating the weight data may include various variables and loop conditions for parsing through the trained machine learning model, and identifying and extracting weights that are associated with specific network layers in the trained machine learning model. Such variables may include variables for identifying network layers, size and dimensions of the weight tensor for the network layer, and/or counts of the number of weights associated with the network layers. Such loop conditions may control the order in which the weight data is extracted from the trained machine learning model, such as by network layer and/or by dimension of the weight tensor.

The code block 400 may initialize a data structure to which to write the weight data and/or a format in which to write out the weight data to the weight data file. In a non-limiting example, the data structure and/or format may be a floating-point array in which the weight data may be organized by dimension of the weight tensor. The code block 400 may write out the weight data to the weight data file according the parameters for generating the weight data in the format in which to write out the weight data to the weight data file. The code block 400 may output the weight data file. In a non-limiting example, the output weight data file may be a renamed version of the header file, referred to in FIG. 4 as “conv2d.h.”

The code block 402 may use a layer template (e.g., layer template 312 in FIG. 3) as an input. In a non-limiting example, the layer template may be a template for a network layer of a convolutional neural network, referred to in FIG. 4 as “conv2d.template.” The code block 402 may generate and/or open a layer code file (e.g., layer code 316 in FIG. 3) to which to write the weight data. In a non-limiting example, the layer code file may be a C programing language source code file, referred to in FIG. 4 as “conv2d.c.” The code block 402 may open and read the layer template, and write the contents of the layer template to the layer code file. In some embodiments, the code block 402 may be implemented multiple times for a trained machine learning model. In some embodiments, the code block 402 may be implemented for each network layer of the trained machine learning model. In some embodiments, the code block 402 may be implemented using different layer templates depending on the network layer of the trained machine learning model for which the code block 402 is implemented. In some embodiments, subsequent implementations of the code block 402 may generate additional layer code files or may add to the layer code file for the trained machine learning model.

The code block 404 may be a template for the network layer of the trained machine learning model for which the code block 402 is implemented (e.g., as described with respect to the code, block 402). In a non-limiting example, the layer template may be a template for a network layer of a convolutional neural network, referred to in FIG. 4 as “conv2d.template.” The code block 404 may initialize various parameters defining the type of network layer of the layer template. In a non-limiting example, such parameters may include a network layer name, network layer dimensions, input data for the network layer, output data for the network layer, feature modifications for the network layer, bias for the network layer, etc. The code block 404 may include flow control code for the network layer. In a non-limiting example, the flow control code may include code to implement a forward pass of the network layer using the parameters defining the type of network layer.

The code block 406 may use weight data output by the code block 400 and layer code output by the code block 402 as inputs. In a non-limiting example, the weight data input to the code block 406 may be the header file, referred to in FIG. 4 as “conv2d.h,” and the layer code input to the code block 406 may be the source code file, referred to in FIG. 4 as “conv2d.c.” The code block 406 may generate code initializing the weight data. In a non-limiting example, the weight data may be initialized in a format of a floating-point array. In some embodiments, the initialized weight data may be in the same format as the input weight data.

The code block 406 may generate code initializing the network layers of the layer code input, which may include setting the various parameters of each network layer. In some embodiments, the values of the parameters of the network layers may be determined from parsing the trained machine learning model, such as using the weight data. The code block 406 may generate code for executing the network layers of the layer code input, which may include setting the input variable of each network layer. In some embodiments, the input variable of a first network layer may be an input to a software program using the network construct source code (e.g., network construct source code 304 in FIG.). In some embodiments, the input variable of successive network layers may be an output of a preceding network layer.

The code block 406 may output the generated code as the network construct source code 304. In some embodiments, the code block 406 may output the generated code as a network construct source code file containing the network construct source code. In a non-limiting example, the network construct source code file may be a C programing language source code file, referred to in FIG. 4 as “network.c.”

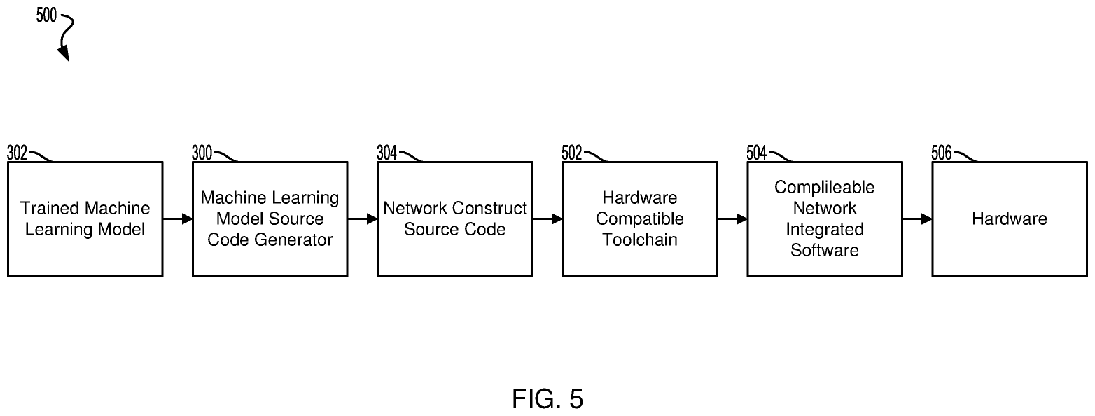

FIG. 5 illustrates an example system for generating source code of trained machine learning models and implementing hardware specific software using the generated source code suitable for implementing various embodiments. With reference to FIGS. 1-5, in a machine learning-edge processing system 500, a trained machine learning model 302 may be provided to a machine learning model source code generator 300. Using the trained machine learning model 302, the machine learning model source code generator 300 may generate a network construct source code 304, as described with reference to FIGS. 3 and 4. As previously described, the network construct source code 304 may be source code of the trained machine learning model 302, including the weights and the type of network layer, network layer execution, and/or network layer flow control, in a programming language that is compileable and executable by a hardware 506, such as an edge processing device (e.g., edge processor 124 and other edge processors described with reference to FIG. 1, modem DSP 212, APU 214, and other edge processors described with reference to FIG. 2).

A software and/or firmware developer, which may also be a hardware developer of the hardware 506, may develop software and/or firmware for execution by the hardware 506 using a hardware compatible toolchain 502, which is also referred to herein as an existing, dedicated firmware toolchain. The software and/or firmware may be a compileable network integrated software and/or firmware 504 that incorporates the network construct source code 304 to implement the trained machine learning model 302 by the hardware 506.

In some embodiments, the network integrated software and/or firmware 504 may be compiled and provided in an executable format to the hardware 506. In some embodiments, the network integrated software and/or firmware 504 may be provided to the hardware 506. The hardware 506 may compile the network integrated software and/or firmware 504 to an executable format. The hardware 506 may execute the compiled network integrated software and/or firmware 504. Executing the compiled network integrated software and/or firmware 504 may cause the hardware to implement the trained machine learning model 302.

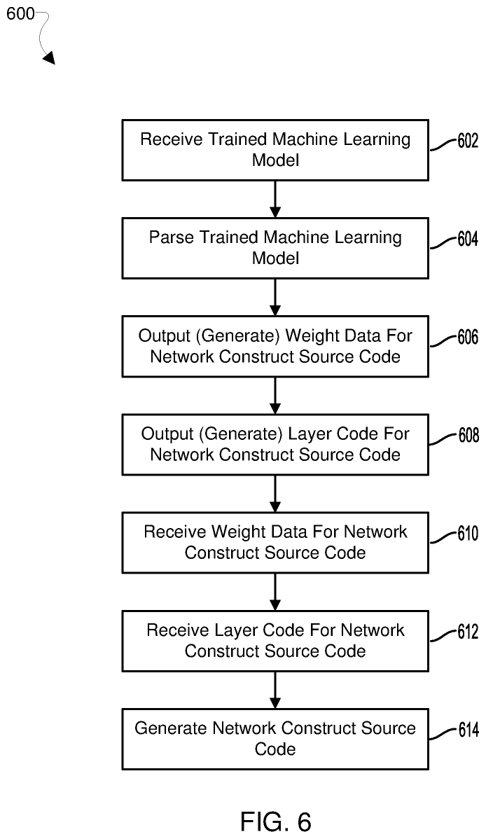

FIG. 6 illustrates a method 600 for generating source code of trained machine learning models according to some embodiments. With reference to FIGS. 1-6, the method 600 may be implemented in a computing device (e.g., computing device 100 in FIG. 1), in general purpose hardware (e.g., processor 104 in FIG. 1), in dedicated hardware (e.g., edge processor(s) 124 and other edge processors described with reference to FIG. 1, modem DSP 212, APU 214, and other edge processors described with reference to FIG. 2), in software executing in a processor (e.g., machine learning model source code generator 300, machine learning model parser 306, weight analyzer and generator 308, layer code analyzer and generator 310, layer templates 312, network construct code generator 318 described with reference to FIGS. 3-5), or in a combination of a software-configured processor and dedicated hardware. In order to encompass the alternative configurations enabled in various embodiments, the hardware implementing the method 600 is referred to herein as a “processing device.”

In block 602, the processing device may receive a trained machine learning model (e.g., trained machine learning model 302 described with reference to FIGS. 3-5). The trained machine learning model may include SDK libraries that are not adapted to be complied and executed by an edge processing device. The trained machined learning model may include weights and network layers for implementing the trained machine learning model. In some embodiments, the processing device receiving the trained machine learning model in block 602 may be one or more general purpose processors. In some embodiments, the processing device receiving the trained machine learning model in block 602 may be one or more edge processing devices.

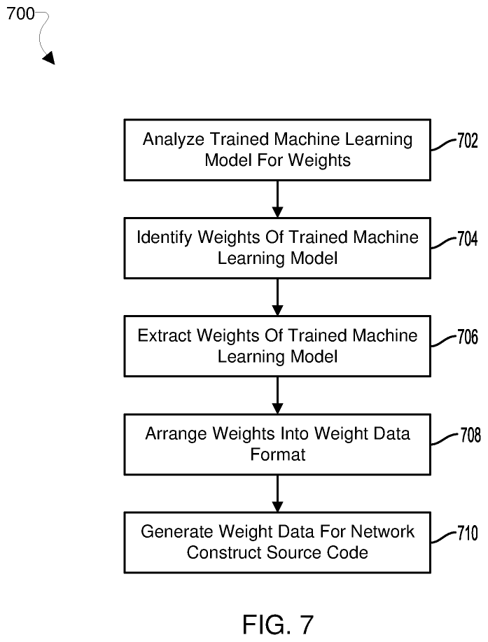

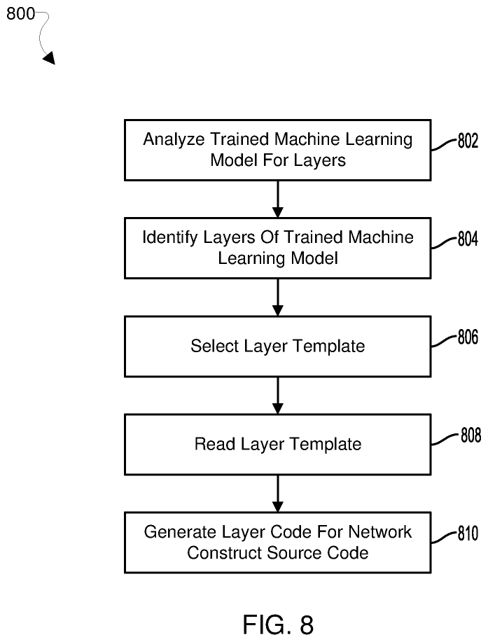

In block 604, the processing device may parse the trained machine learning model. The processing device may be configured to parse the trained machine learning model to locate, identify, and extract weights of the trained machine learning model, as described further herein with reference to the method 700 illustrated in FIG. 7. The processing device may be configured to parse the trained machine learning model to locate and identify network layers of the trained machine learning model, as described further herein with reference to the method 800 illustrated in FIG. 8. In some embodiments, the processing device parsing the trained machine learning model in block 604 may be one or more general purpose processors. In some embodiments, the processing device parsing the trained machine learning model in block 604 may be one or more edge processing devices.

In block 606, the processing device may output (generate) weight data (e.g., weight data 314 described with reference to FIGS. 3 and 4) for use in generating a network construct source code (e.g., network construct source code 304 described with reference to FIGS. 3-5). The processing device may output the weight data., for example, by storing the weight data to a memory (e.g., memory 106, 114 in FIG. 1, system cache 202, RAM 228, and various cache memories described with reference to FIG. 2). In some embodiments, the processing device outputting the weight data in block 606 may be one or more general purpose processors. In some embodiments, the processing device outputting the weight data in block 606 may be one or more edge processing devices.

In block 608, the processing device may output (generate) layer code (e.g., layer code 316 described with reference to FIGS. 3 and 4) for use in generating the network construct source code. The processing device may output the layer code, for example, by storing the layer code to the memory. In some embodiments, the processing device outputting the layer code in block 608 may be one or more general purpose processors. In some embodiments, the processing device outputting the layer code in block 608 may be one or more edge processing devices.

In block 610, the processing device may receive the weight data for use in generating the network construct source code. The processing device may receive the weight data, for example, by retrieving the weight data from the memory. In some embodiments, the processing device receiving the weight data in block 610 may he one or more general purpose processors. In some embodiments, the processing device receiving the weight data in block 610 may be one or more edge processing devices.

In block 612, the processing device may receive the layer code for use in generating the network construct source code. The processing device may receive the layer code, for example, by retrieving the layer code from the memory. In some embodiments, the processing device receiving the layer code in block 612 may be one or more general purpose processors. In some embodiments, the processing device receiving the layer code in block 612 may be one or more edge processing devices.

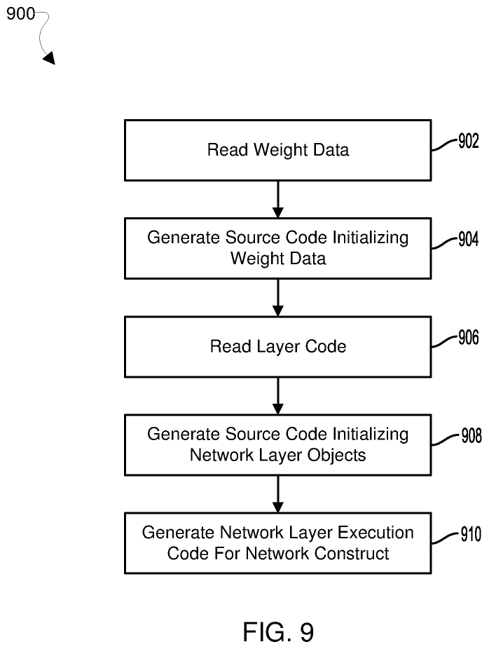

In block 614, the processing device may generate the network construct source code. The processing device may be configured to generate source code for implementing the trained machine learning model that is compileable and executable by an edge processing device, as described further herein with reference to the method 900 illustrated in FIG. 9. In some embodiments, the processing device generating the network construct source code in block 614 may be one or more general purpose processors. In some embodiments, the processing device generating the network construct source code in block 614 may be one or more edge processing devices.

In some embodiments, the processing device may write out the network construct source code to a memory (e.g., memory 106, 114 in FIG. 1, system cache 202, RAM 228, and various cache memories described with reference to FIG. 2). In some embodiments, the processing device may store the network construct source code in the memory in a specific file format. For example, the network construct source code may be stored in the memory in a source code file. In whichever manner the network construct source code is stored in the memory, the format of the network construct source code may be a format compileable and implementable by an edge processing device.

The foregoing description of the method 600 and the process flow illustrated in FIG. 6 are provided merely as illustrative examples and are not intended to require or imply that the operations of the various embodiments must be performed in the order presented. As will be appreciated by one of skill in the art, the order of operations in the foregoing embodiment descriptions may be performed in any order. In some embodiments, block 608 may be implemented prior to and/or concurrent with block 606. In some embodiments, block 610 may be implemented prior to and/or concurrent with block 608. In some embodiments, block 612 may be implemented prior to and/or concurrent with one or more any of blocks 606, 610.

FIG. 7 illustrates a method 700 for parsing weights of trained machine learning models according to some embodiments. With reference to FIGS. 1-7, the method 700 may be implemented in a computing device (e.g., computing device 100 in FIG. 1), in general purpose hardware (e.g., processor 104 in FIG. 1), in dedicated hardware (e.g., edge processor(s) 124 and other edge processors described with reference to FIG. 1, modem DSP 212, APU 214, and other edge processors described with reference to FIG. 2), in software executing in a processor (e.g., machine learning model source code generator 300, machine learning model parser 306, weight analyzer and generator 308 described with reference to FIGS. 3-5), or in a combination of a software-configured processor and dedicated hardware. In order to encompass the alternative configurations enabled in various embodiments, the hardware implementing the method 700 is referred to herein as a “processing device.”

In block 702, the processing device may analyze a trained machine learning model (e.g., trained machine learning model described with reference to FIGS. 3-5) for weights. The trained machine learning model may include SDK libraries that contain weights for the trained machine learning model and that are not adapted to be complied and executed by an edge processing device. The processing device may be configured to parse the trained machine learning model to locate and identify weight values of the trained machine learning model. The processing device may be configured to locate and identify data that matches criteria for a format of the weights of the trained machine learning model. For example, the weights may be of a specific data type, stored as a specific data structure, labeled using a specific variable identifier, etc. In some embodiments, different criteria may be used by the processing device to parse and analyze the trained machine learning model to locate and identify weight values of different trained machine learning models. In some embodiments, the processing device analyzing the trained machine learning model for weights in block 702 may be one or more general purpose processors. In some embodiments, the processing device analyzing the trained machine learning model for weights in block 702 may be one or more edge processing devices.

In block 704, the processing device may identify weights of the trained machine learning model. The processing device may identify data in the trained. machine learning model SDK libraries that meet the criteria for identifying weight values. The processing device may compare the contents of the trained machine learning model SDK libraries to the criteria for identifying weight values, and identify a weight value from content that meets the criteria. In some embodiments, the processing device identifying weights of the trained machine learning model in block 704 may be one or more general purpose processors. In some embodiments, the processing device identifying weights of the trained machine learning model in block 704 may be one or more edge processing devices.

In block 706, the processing device may extract weights of the trained machine learning model. The processing device may be configured to extract weight value data from the trained machine learning model SDK libraries for weights identified in block 704. In some embodiments, to extract the extract the weights from the trained machine learning model, the processing device may write out the weight value data of the identified weights to a memory (e.g., memory 106, 114 in FIG. 1, system cache 202, RAM 228, and various cache memories described with reference to FIG. 2). In some embodiments, the processing device extracting weights of the trained machine learning model in block 706 may be one or more general purpose processors. In some embodiments, the processing device extracting weights of the trained machine learning model in block 706 may be one or more edge processing devices.

In block 708 the processing device may arrange the weights into a weight data format. In some embodiments, the weights may be stored as weight data (e.g., weight data 314 as described with reference to FIGS. 3 and 4) in the memory in a specific format, such as using a specific data type, stored as a specific data structure, labeled using a specific variable identifier, etc. For example, the weight data may be stored in the memory as floating-point values in an array. In some embodiments, the processing device arranging the weights into a weight data format in block 708 may be one or more general purpose processors. In some embodiments, the processing device arranging the weights into a weight data format in block 708 may be one or more edge processing devices.

In block 710, the processing device may generate the weight data for use in generating a network construct source code (e.g., network construct source code 304 as described with reference to FIGS. 3-5). The processing device may be configured to format the weight data stored in the memory in a specific file format. For example, the weight data may be stored in the memory in a header file. In some embodiments, the file format may be a file format usable by the processing device to generate a network construct source code as described herein for block 614 of the method 600 with reference to FIG. 6. In some embodiments, the processing device generating the weight data for use in generating a network construct source code in block 710 may be one or more general purpose processors. In some embodiments, the processing device generating the weight data for use in generating a network construct source code in block 710 may be one or more edge processing devices.

In some embodiments, any or all of blocks 702, 704, 706, 708, 710 may be implemented for each weight of the trained machine learning model.

FIG. 8 illustrates a method 800 for parsing network layers of trained machine learning models according to some embodiments. With reference to FIGS. 1-8, the method 800 may be implemented in a computing device (e.g., computing device 100 in FIG. 1), in general purpose hardware (e.g., processor 104 in FIG. 1), in dedicated hardware (e.g., edge processor(s) 124 and other edge processors described with reference to FIG. 1, modem DSP 212, APU 214, and other edge processors described with reference to FIG. 2), in software executing in a processor (e.g., machine learning model source code generator 300, machine learning model parser 306, layer code analyzer and generator 310, layer templates 312 described with reference to FIGS. 3-5), or in a combination of a software-configured processor and dedicated hardware. In order to encompass the alternative configurations enabled in various embodiments, the hardware implementing the method 800 is referred to herein as a “processing device.”

In block 802, the processing device may analyze a trained machine learning model (e.g., trained machine learning model described with reference to FIGS. 3-5) for network layers. The trained machine learning model may include SDK libraries that contain network layers for the trained machine learning model and that are not adapted to be complied and executed by an edge processing device. The processing device may be configured to parse the trained machine learning model to locate and identify a type of network layer, network layer execution, and/or network layer flow control of the trained machine learning model. The processing device may be configured to locate and identify code that matches criteria for a format of the type of network layer, network layer execution, and/or network layer flow control of the trained machine learning model. For example, the type of network layer, network layer execution, and/or network layer flow control may use specific function calls, specific code patterns, such as loops, be labeled using specific identifiers, etc. In some embodiments, different criteria may be used by the processing device to parse the trained machine learning model to locate and identify the type of network layer, network layer execution, and/or network layer flow control of different trained machine learning models. In some embodiments, the processing device analyzing the trained machine learning model for network layers in block 802 may be one or more general purpose processors. In some embodiments, the processing device analyzing the trained machine learning model for network layers in block 802 may be one or more edge processing devices.

In block 804, the processing device may identify network layers of the trained machine learning model. The processing device may identify contents in the trained machine learning model SDK libraries that meet the criteria for identifying network layers. The processing device may compare the contents of the trained machine learning model SDK libraries to the criteria for identifying network layers, and identify a network layer from content that meets the criteria. In some embodiments, the processing device identifying network layers of the trained machine learning model in block 804 may be one or more general purpose processors. In some embodiments, the processing device identifying network layers of the trained machine learning model in block 804 may be one or more edge processing devices.

In block 806, the processing device may select a layer template. The processing device may be configured to select a layer template based on the identified type of network layer, network layer execution, and/or network layer flow control. Each layer template may correspond to a type of layer of a network. Layer templates may be preconfigured to correspond with any type of network layer. A layer template may be configured to provide source code for execution and flow control of a type of network layer in a programming language that is compileable and executable by an edge processing device. For example, the layer template may include specific function calls, specific code patterns, such as loops, specific identifiers, etc. that are configured to implement the network layer execution and flow control. In some embodiments, different layer template may include different code for implementing network layer execution and flow control for different layers of different trained machine learning models. In some embodiments, the processing device selecting a layer template in block 806 may be one or more general purpose processors. In some embodiments, the processing device selecting a layer template in block 806 may be one or more edge processing devices.

In block 808, the processing device may read the selected layer template. The processing device may be configured to generate layer code (e.g., layer code 316 as described with reference to FIGS. 3 and 4) for use in generating network construct source code (e.g., network construct source code 304 as described with reference to FIGS. 3-5) using selected layer templates. In some embodiments, the processing device may read the code of the selected layer templates. Reading the selected layer template may provide the processing device with source code for initialization, execution, and/or flow control of the network layer. In some embodiments, the processing device reading the selected layer template in block 808 may be one or more general purpose processors. In some embodiments, the processing device reading the selected layer template in block 808 may be one or more edge processing devices.

In block 810, the processing device may generate the layer code for use in generating a network construct source code. The processing device may write out the code of the selected layer templates to a memory (e.g., memory 106, 114 in FIG. 1, system cache 202, RAM 228, and various cache memories described with reference to FIG. 2). In some embodiments, the code of the selected layer templates may be stored as layer code in the memory in a specific file format. For example, the layer code may be stored in the memory in a source code file. In some embodiments, the file format may be a file format usable by the processing device to generate a network construct source code as described herein for block 614 of the method 600 with reference to FIG. 6. In some embodiments, the processing device generating the layer code for use in generating a network construct source code in block 810 may be one or more general purpose processors. In some embodiments, the processing device generating the layer code for use in generating a network construct source code in block 810 may be one or more edge processing devices.

In some embodiments, any or all of blocks 802, 804, 806, 808, 810 may be implemented for each network layer of the trained machine learning model.

FIG. 9 illustrates a method 900 for generating source code of trained machine learning models according to some embodiments. With reference to FIGS. 1-9, the method 900 may be implemented in a computing device (e.g., computing device 100 in FIG. 1), in general purpose hardware (e.g., processor 104 in FIG. 1), in dedicated hardware (e.g., edge processor(s) 124 and other edge processors described with reference to FIG. 1, modem DSP 212, APU 214, and other edge processors described with reference to FIG. 2), in software executing in a processor (e.g., machine learning model source code generator 300, network construct code generator 318 described with reference to FIGS. 3-5), or in a combination of a software-configured processor and dedicated hardware. In order to encompass the alternative configurations enabled in various embodiments, the hardware implementing the method 900 is referred to herein as a “processing device.”

In block 902, the processing device may read weight data (e.g., weight data 314 as described with reference to FIGS. 3 and 4). The processing device may read the weight data received in block 610 of the method 600 as described with reference to FIG. 6. In some embodiments, the processing device reading weight data in block 902 may be one or more general purpose processors. In some embodiments, the processing device reading weight data in block 902 may be one or more edge processing devices.

In block 904, the processing device may generate source code initializing the weight data values in a network construct source code (e.g., network construct source code 304 as described with reference to FIGS. 3-5). In some embodiments, the processing device may generate source code initializing a data structure having the weight data values read from the weight data in block 902. For example, the processing device may initialize an array having the weight data values. In some embodiments, the processing device generating source code initializing the weight data values in a network construct source code in block 904 may be one or more general purpose processors. In some embodiments, the processing device generating source code initializing the weight data values in a network construct source code in block 904 may be one or more edge processing devices.

In block 906, the processing device may read layer code (e.g., layer code 316 as described with reference to FIGS. 3 and 4). The processing device may read the layer code received as described herein in block 612 of the method 600 with reference to FIG. 6. In some embodiments, the processing device reading layer code in block 906 may be one or more general purpose processors. In some embodiments, the processing device reading layer code in block 906 may be one or more edge processing devices.

In block 908, the processing device may generate source code initializing network layer objects. The processing device may generate source code for network layer objects based on the layer code read in block 906, which may indicate to the processing device the types of network layers, the order of the network layers, and the parameters of the network layers. In some embodiments, the processing device may determine values of parameters of the network layer objects from parsing the trained machine learning model (e.g., trained machine learning module 302) in block 604 of the method 600 as described with reference to FIG. 6. In some embodiments, the processing device may use weight data in determining and setting the parameter values of the network layer objects. For example, the weight data may be used to generate parameter values for the sizes, dimensions, and/or number of network layers in the network construct source code. In some embodiments, the processing device generating source code initializing network layer objects in block 908 may be one or more general purpose processors. In some embodiments, the processing device generating source code initializing network layer objects in block 908 may be one or more edge processing devices.

In block 910, the processing device may generate source code for execution and flow control of a network construct of a trained machine learning model. The processing device may generate source code for execution and flow control of the network construct based on the layer code read in block 906, which may indicate to the processing device the order of the network layers and the execution steps for each network layer.

In some embodiments, the execution steps for a network layer may depend on the type of network layer. For example, a layer template (e.g., layer template 312 as described with reference to FIGS. 3 and 4) for a network layer may include an execution step of a forward pass of the layer, and such execution step may be included in the layer code. Based on the order of the network layers, the processing device may generate source code in which the input to a software program implementing the source code for execution and flow control of the network construct is an input to the software and/or an input generated by the software. Based on the order of the network layers, the processing device may generate source code in which the output of a network layer is an input to an execution step for a subsequent network layer. The processing device may generate source code for execution and flow control of each of the network layer objects. In some embodiments, the processing device generating generate source code for execution and flow control of a network construct of a trained machine learning model in block 910 may be one or more general purpose processors. In some embodiments, the processing device generating source code for execution and flow control of a network construct of a trained machine learning model in block 910 may be one or more edge processing devices.

In some embodiments, any or all of blocks 902, 904, 906, 908, 910 may be implemented for each weight data and/or layer code for the trained machine learning model.

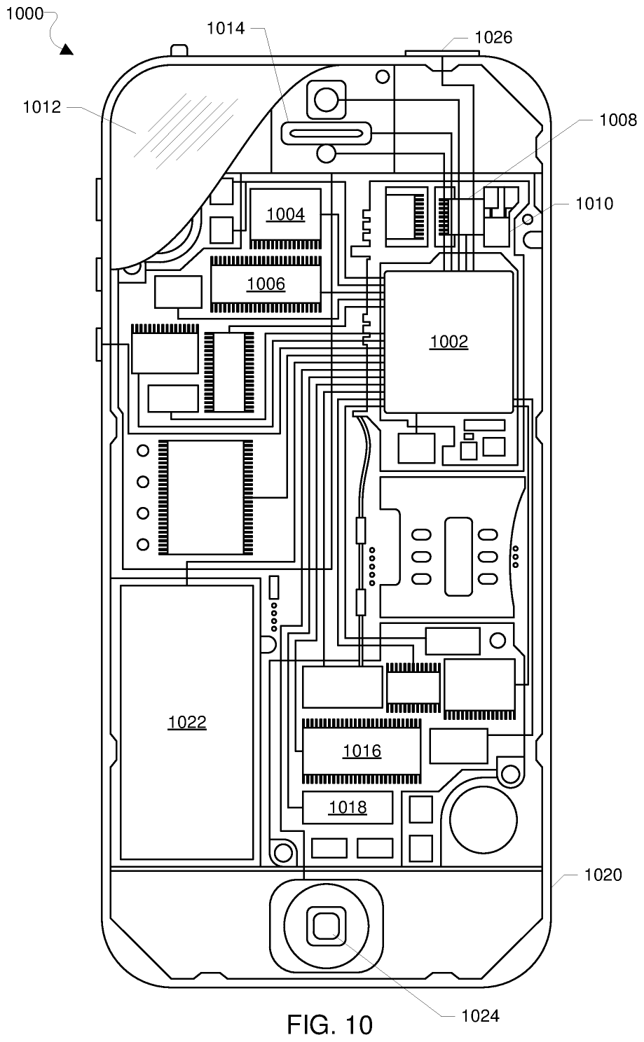

Methods and devices for implementing such methods in accordance with the various embodiments (including, but not limited to, embodiments described above with reference to FIGS. 1-9) may be implemented in a wide variety of computing systems including mobile computing devices, an example of which suitable for use with the various embodiments is illustrated in FIG. 10. The mobile computing device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the mobile computing device 1000 need not have touch screen capability

The mobile computing device 1000 may have one or more radio signal transceivers 1008 (e.g., Peanut, Bluetooth, ZigBee, Wi-Fi, RF radio) and antennae 1010 for sending and receiving communications, coupled to each other and/or to the processor 1002. The transceivers 1008 and antennae 1010 may be used with the above-mentioned circuitry to implement the various wireless transmission protocol stacks and interfaces. The mobile computing device 1000 may include a cellular network wireless modem chip 1016 that enables communication via a cellular network and is coupled to the processor.

The mobile computing device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as Universal Serial Bus (USB), FireWire, Thunderbolt, or PCIe. The peripheral device connection interface 1018 may also be coupled to a similarly configured peripheral device connection port (not shown).

The mobile computing device 1000 may also include speakers 1014 for providing audio outputs. The mobile computing device 1000 may also include a housing 1020, constructed of a plastic, metal, or a combination of materials, for containing all or some of the components described herein. The mobile computing device 1000 may include a power source 1022 coupled to the processor 1002, such as a disposable or rechargeable battery. The rechargeable battery may also be coupled to the peripheral device connection port to receive a charging current from a source external to the mobile computing device 1000. The mobile computing device 1000 may also include a physical button 1024 for receiving user inputs. The mobile computing device 1000 may also include a power button 1026 for turning the mobile computing device 1000 on and off.

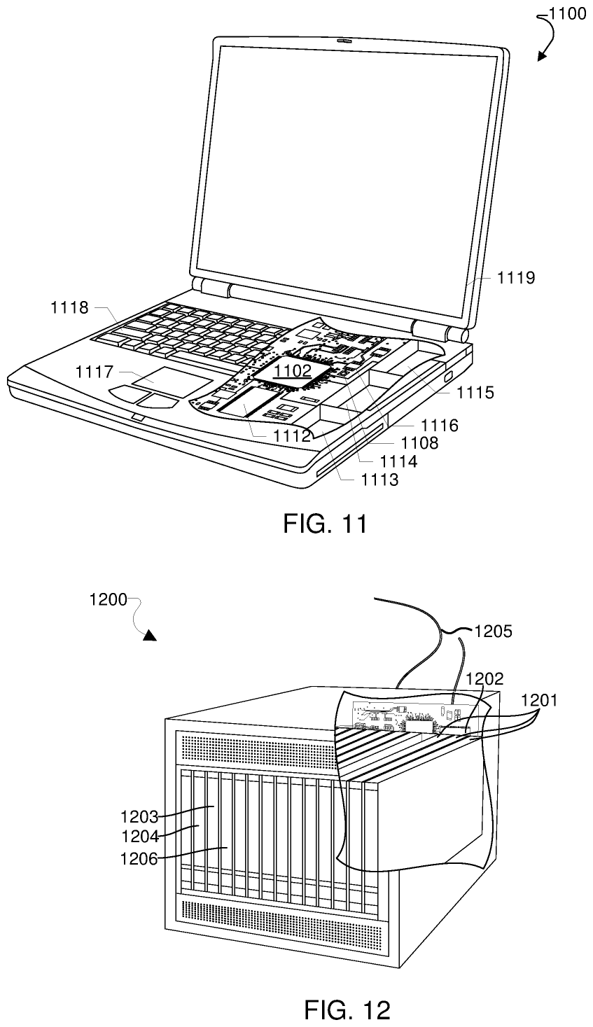

Methods and devices for implementing such methods in accordance with the various embodiments (including, but not limited to, embodiments described above with reference to FIGS. 1-9) may be implemented in a wide variety of computing systems include a laptop computer 1100 an example of which is illustrated in FIG. 11. A laptop computer 1100 will typically include a processor 1102 coupled to volatile memory 1112 and a large capacity nonvolatile memory, such as a compact disc (CO) drive 1113 or Flash memory. Additionally, the computer 1100 may have one or more antenna 1108 for sending and receiving electromagnetic radiation that may be connected to a wireless data link and/or cellular telephone transceiver 1116 coupled to the processor 1102. The computer 1100 may also include a floppy disc drive 1114 and a CD drive 1113 coupled to the processor 1112. In a notebook configuration, the computer housing may include a battery 1115, a touchpad touch surface 1117 that serves as the computer's pointing device, a keyboard 1118, and a display 1119 all coupled to the processor 1102. Other configurations of the computing device may include a computer mouse or trackball coupled to the processor (e.g., via a USB input) as are well known, which may also be used in conjunction with the various embodiments.

Methods and devices for implementing such methods in accordance with the various embodiments (including, but not limited to, embodiments described above with reference to FIGS. 1-9) may also be implemented in fixed computing systems, such as any of a variety of commercially available servers. An example server 1200 is illustrated in FIG. 12. Such a server 1200 typically includes one or more multicore processor assemblies 1201 coupled to volatile memory 1202 and a large capacity nonvolatile memory, such as a disk drive 1204. As illustrated in FIG. 12, multicore processor assemblies 1201 may be added to the server 1200 by inserting them into the racks of the assembly. The server 1200 may also include a floppy disc drive, compact disc (CD) or digital versatile disc (DVD) disc drive 1206 coupled to the processor 1201. The server 1200 may also include network access ports 1203 coupled to the multicore processor assemblies 1201 for establishing network interface connections with a network 1205, such as a local area network coupled to other broadcast system computers and servers, the Internet, the public switched telephone network, and/or a cellular data network (e.g., CDMA, TDMA, GSM, PCS, 3G, 4G, LTE, 5G, or any other type of cellular data network).

Further details regarding various embodiments are described in Appendix A hereto, which is part of this specification disclosure as if included within the numbered paragraphs.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method for generating source code of one or more trained machine learning models for use with an existing toolchain of an edge processing device, comprising:
parsing a trained machine learning model;
generating weight data from the parsed trained machine learning model;
generating layer code from the parsed trained machine learning model; and
generating a network construct source code of the trained machine learning model from the weight data and the layer code, wherein the network construct source code is compileable for and executable by the edge processing device.

2. The method of claim 1, wherein generating weight data from the parsed trained machine learning model comprises:
identifying weights in the trained machine learning model;
extracting the weights of the trained machine learning model; and
storing the extracted weights as the weight data.

3. The method of claim 1, wherein generating layer code from the parsed trained machine learning model comprises:
identifying network layers in the trained machine learning model;
selecting layer templates corresponding to the identified network layers; and
storing contents of the layer templates as the layer code.

4. The method of claim 1, wherein generating a network construct source code comprises:
generating source code initializing weights using the weight data;
generating source code initializing network layer objects using the layer code; and
generating source code for network layer execution using the layer code.

5. The method of claim 1, wherein generating weight data from the parsed trained machine learning model comprises generating a header file having weights of the trained machine learning model.

6. The method of claim 1, wherein generating layer code from the parsed trained machine learning model comprises generating a source code file having network layer objects and network layer execution code for network layers of the trained machine learning model.

7. The method of claim 1, wherein generating a network construct source code of the trained machine learning model comprises generating a C programming language source code file having source code initializing weights of the trained machine learning model, source code initializing network layer objects for network layers of the trained machine learning model, and source code for network layer execution for the network layers of the trained machine learning model.

8. A computing device configured for generating source code of one or more trained machine learning models for use with an existing toolchain of an edge processing device, the computing device comprising:
a processing device configured with processor-executable instructions to perform operations comprising:
parsing a trained machine learning model;
generating weight data from the parsed trained machine learning model;
generating layer code from the parsed trained machine learning model; and
generating a network construct source code of the trained machine learning model from the weight data and the layer code, wherein the network construct source code is compileable for and executable by the edge processing device.

9. The computing device of claim 8, wherein the processing device is configured with processor-executable instructions to perform operations such that generating weight data from the parsed trained machine learning model comprises:
identifying weights in the trained machine learning model;
extracting the weights of the trained machine learning model; and
storing the extracted weights as the weight data.

10. The computing device of claim 8, wherein the processing device is configured with processor-executable instructions to perform operations such that generating layer code from the parsed trained machine learning model comprises:
identifying network layers in the trained machine learning model;
selecting layer templates corresponding to the identified network layers; and
storing contents of the layer templates as the layer code.

11. The computing device of claim 8, wherein the processing device is configured with processor-executable instructions to perform operations such that generating a network construct source code comprises:
generating source code initializing weights using the weight data;
generating source code initializing network layer objects using the layer code; and
generating source code for network layer execution using the layer code.

12. The computing device of claim 8, wherein the processing device is configured with processor-executable instructions to perform operations such that generating weight data from the parsed trained machine learning model comprises generating a header file having weights of the trained machine learning model.

13. The computing device of claim 8, wherein the processing device is configured with processor-executable instructions to perform operations such that generating layer code from the parsed trained machine learning model comprises generating a source code file having network layer objects and network layer execution code for network layers of the trained machine learning model.

14. The computing device of claim 8, wherein the processing device is configured with processor-executable instructions to perform operations such that generating a network construct source code of the trained machine learning model comprises generating a C programming language source code file having source code initializing weights of the trained machine learning model, source code initializing network layer objects for network layers of the trained machine learning model, and source code for network layer execution for the network layers of the trained machine learning model.

15. A computing device, comprising:
means for parsing a trained machine learning model;
means for generating weight data from the parsed trained machine learning model;
means for generating layer code from the parsed trained machine learning model; and
means for generating a network construct source code of the trained machine learning model from the weight data and the layer code, wherein the network construct source code is compileable for and executable by the edge processing device.

116. A non-transitory processor-readable storage medium having stored thereon processor-executable instructions configured to cause a processing device of a computing device to perform operations comprising:
parsing a trained machine learning model;
generating weight data from the parsed trained machine learning model;
generating layer code from the parsed trained machine learning model; and
generating a network construct source code of the trained machine learning model from the weight data and the layer code, wherein the network construct source code is compileable for and executable by the edge processing device.

17. The non-transitory processor-readable storage medium of claim 16, wherein the stored processor-executable instructions are configured to cause the processing device of the computing device to perform operations such that generating weight data from the parsed trained machine learning model comprises:
identifying weights in the trained machine learning model;
extracting the weights of the trained machine learning model; and
storing the extracted weights as the weight data.

18. The non-transitory processor-readable storage medium of claim 16, wherein the stored processor-executable instructions are configured to cause the processing device of the computing device to perform operations such that generating layer code from the parsed trained machine learning model comprises:
identifying network layers in the trained machine learning model;
selecting layer templates corresponding to the identified network layers; and
storing contents of the layer templates as the layer code.

19. The non-transitory processor-readable storage medium of claim 16, wherein the stored processor-executable instructions are configured to cause the processing device of the computing device to perform operations such that generating a network construct source code comprises:
generating source code initializing weights using the weight data;
generating source code initializing network layer objects using the layer code; and
generating source code for network layer execution using the layer code.

20. The non-transitory processor-readable storage medium of claim 16, wherein the stored processor-executable instructions are configured to cause the processing device of the computing device to perform operations such that generating weight data from the parsed trained machine learning model comprises generating a header file having weights of the trained machine learning model.

21. The non-transitory processor-readable storage medium of claim 16, wherein the stored processor-executable instructions are configured to cause the processing device of the computing device to perform operations such that generating layer code from the parsed trained machine learning model comprises generating a source code file having network layer objects and network layer execution code for network layers of the trained machine learning model.

22. The non-transitory processor-readable storage medium of claim 16, wherein the stored processor-executable instructions are configured to cause the processing device of the computing device to perform operations such that generating a network construct source code of the trained machine learning model comprises generating a C programming language source code file having source code initializing weights of the trained machine learning model, source code initializing network layer objects for network layers of the trained machine learning model, and source code for network layer execution for the network layers of the trained machine learning model.
